(19) United States
(12) Patent Application Publication
(10) Pub. No.: US 2011/0254248 A1
(43) Pub. Date: Oct. 20, 2011

(54) VEHICLE-TOWING APPARATUS WHICH IS COMPACTABLE FOR STORAGE IN A VEHICLE

(76) Inventor: Avraham Elkayam, Ramat Gan (IL)

(21) Appl. No.: 13/141,699

(22) PCT Filed: Dec. 10, 2009
(86) PCT No.: PCT/IB09/55649

§ 371 Date: Jun. 23, 2011

(30) Foreign Application Priority Data
Dec. 24, 2008 (IL) 196160

(51) Int. Cl. B62D 61/12

(52) U.S. Cl. 280/415.1

(57) ABSTRACT

A towing apparatus, the apparatus includes two or more parallel wheel assemblies, one or more load-bearing platform, operationally coupled one or more of the wheel assemblies, and an expansion mechanism for changing a transverse distance between the two parallel wheel assemblies to reversibly configure the towing apparatus alternately between a closed state and an open state.

### FIELD AND BACKGROUND OF THE INVENTION

The present invention relates to a towing apparatus and, more particularly, to a towing cart capable of towing vehicles and being compactable.

In the field of roadside assistance and in-place car servicing, it is common practice for roadside and vehicle service providers to employ mechanics and provide them with mobile capabilities (e.g. a servicing van) with which to provide service to vehicles which have broken down on the side of the road or don't start when at the place where they were previously parked. These mobile service providers or roadside service providers (RSPs) are typically dispatched by their service centers to provide assistance to subscribers to the service who have called the service center and requested assistance. If the problem is one that obviously requires towing (e.g. significant damage to the vehicle due to collision), then a dedicated tow-truck is dispatched. It is common practice to have dedicated towing trucks to facilitate the removal and transference of vehicles that have experienced mechanical and/or technical problems, which cannot be fixed in-place, to a service station such as a local garage. On the other hand, if the problem is one that can be solved on location, for example, a punctured tire or ‘dead battery’, it is more pertinent to send a roadside service provider to the location, to provide immediate assistance. The decision whether to send a tow truck or a roadside service provider is made at the service center, based on the description of the problem. This decision is based, among other things, on (a) the cost effectiveness of towing a vehicle (often an outsourced service); (b) convenience to the subscriber or caller; (c) cost-effective use of resources, as in: (i) the more people serviced, the great the financial gain; (ii) service provided within reasonable timeframe after request gives the service center a good reputation which will lead to future requests from the original caller as well as his or her friends; (iii) additional service personal, decrease the net gain from each service provided. It is relatively common for the dispatcher to send a RSP to a caller, in response to the description of the problem given by the caller, where the RSP arrives on location and decides that the vehicle in question needs to be towed and cannot be serviced on-location. The service center now has to send a tow-truck, in addition to the RSP that was already sent, to service the caller. In the previously described scenario, due to the RSP's inability to tow the vehicle himself, there has been a non-cost effective service provided.

U.S. Pat. Nos. 4,230,340, 4,165,096 and WO 2007/060670, which are incorporated by reference for all purposes fully set forth herein, all teach compactable, storable trailers. None of the abovementioned trailer systems are suitable for bearing the heavy load or the unique structure of a vehicle.

The abovementioned towing trailers are compactable in length, longitudinally, from tail end to towing end while remaining the same in width, therefore needing a sufficiently wide storage compartment to store the trailer system. Conventionally used tow-trucks are dedicated vehicles designed specifically for the towing of other vehicles. These tow-trucks are typically large vehicles and consume more gasoline or diesel than the smaller, more fuel efficient and environmentally friendly vehicles, which are typically used by RSPs. In addition, the large size of typical, dedicated, tow-trucks makes maneuverability in suburban areas or on congested roadways more difficult. In the later case, a large vehicle is likely to cause additional congestion on the road or highway. This in turn will increase the related fossil fuel pollution produced by the vehicles that spend more time idling, starting and stopping in the congested traffic situations that have been created or compounded.

Since the towing apparatus of the current invention is capable of being used in the capacity of a regular trailer, it is worthy of note that fixed trailers are often towed even when not in use, up to 50% of the time. This causes significant wear-and-tear which is unjustified. When not in use, a conventional trailer is usually parked in a regular parking space, therefore causing need for an additional parking space.

It would be highly beneficial, therefore, to have a means for the RSP to tow a vehicle at will, whilst said means is not a permanent fixture on the RSP vehicle. Service would further be enhanced if said means was compactable and significantly simple to store in or on the RSP vehicle. The effect on roadway congestion is significantly reduced when using smaller vehicles for towing. This is true for effect on the environment as well as fuel consumption. A storable towing apparatus would also suffer less wear-and-tear than a fixed trailer, which is often not in use but still towed, whereas a storable trailer never needs to be towed unnecessarily. In addition, a fixed trailer, when not in use, takes up parking space that has to be provided therefore, whereas a storable towing apparatus takes up no additional parking spaces.

### SUMMARY OF THE INVENTION

According to the present invention there is provided a towing apparatus including: (a) at least two parallel wheel assemblies, (b) at least one load-bearing platform, operationally coupled to the wheel assemblies, and (c) an expansion mechanism for changing the transverse distance between the two parallel wheel assemblies to reversibly configure the towing apparatus alternately between a closed state and an open state

In some embodiments the towing apparatus further includes two ramps for operationally moving a vehicle onto and off of the load-bearing platforms. Preferably the towing apparatus comprises two load bearing platforms that are substantially adjacent to each other when the towing apparatus is in the closed state. Preferably the expansion mechanism includes two hydraulic cylinders operationally coupled to the load-bearing platforms. Preferably one of the hydraulic cylinders serves as a gate for securing a towed vehicle. Preferably the apparatus further includes a safety latch for securing the hydraulic cylinder when the hydraulic cylinder serves as a gate

In some embodiments the towing apparatus includes four load-bearing platforms wherein each of the load-bearing platforms includes two parallel struts where the first strut is positioned behind a wheel of the towed vehicle and the second strut is positioned in front of the same wheel, thereby securing that wheel. The same holds for the other three wheels. Preferably each load-bearing platform includes a mechanism for adjusting the distance between the two parallel struts, allowing for different wheel sizes as well as different wheel lengths.

In some embodiments the towing apparatus is adapted to be reversibly configured alternately in a lowed state for vehicle entry and exit and in a raised state for unobstructed travel. Preferably the towing apparatus further includes at least one scissor lift for reversibly configuring the towing apparatus alternately in the lowered state and in the raised state. Preferably further including at least one hydraulic cylinder for reversibly configuring the towing apparatus alternately in the lowered state and in the raised state. Preferably, further including two ramps for moving a vehicle onto and off of the load-bearing platforms. Preferably where the load-bearing platforms are configured in the lowered state to lie sufficiently low so as to allow entry and exit of a towed vehicle. Preferably the two ramps are configured to be positioned perpendicular to the load-bearing platforms to secure a towed vehicle.

Preferably the width, when configured in the closed state, is of a ratio of 50% of the width of the towing apparatus when configured in the open state. More preferably the the width, when configured in the closed state, is of a ratio of 30% of the width of the towing apparatus when configured in the open state. Most preferably, the width, when configured in the closed state, is of a ratio of 10% of the width of the towing apparatus when configured in the open state. In some embodiments, the towing apparatus further includes a winch for operatively moving a vehicle onto and off of the towing apparatus.

The present invention successfully addresses the shortcomings of the presently known configurations by providing a towing apparatus, which, in a preferred embodiment, is able to bear the load and unique structure of (at least) a towed vehicle. In addition, the invention is compactable in a manner unique from other towing apparatus. Whereas the abovementioned towing trailers are compactable in length, longitudinally, from tail end to towing end while remaining the same in width, the current invention is compactable in width, transversely, from the wheel assembly on one side to the wheel assembly on the other side. This innovation, whereby the width of the towing apparatus is reduced, allows for relatively easy storage in or on a variety of service vehicles. For example, the towing apparatus can be stored on the flat bed of a pickup truck or in the storage compartment of a minivan.

The present invention discloses an innovative compactably storable towing apparatus capable of towing vehicles as well as other commonly towed elements such as tools or excess baggage. In addition, the invention provides a towing apparatus, which is easily assembled and easily compacted thereby making it relatively easy to store the towing apparatus when not in use and to quickly and easily assemble the towing apparatus when needed. It is therefore not necessary to use a large tow truck for towing vehicles. In addition, the current invention is never towed unnecessarily (because it is easily stored when not in use), reducing the inherent risk of towing a trailer. In addition, there is no unnecessary wear-and-tear on the towing apparatus. Furthermore, the towing apparatus doesn't need a designated parking space when not in use, as it is storable in the towing vehicle.

The towing apparatus of the current invention is typically stored in or on a service vehicle, for example, on the flat bed of a pickup truck. When needed, the apparatus is lowered off the towing vehicle, possibly via ramps (also stored in towing vehicle), and opened, either manually, automatically or partially manually and partially automatically, expanding transversely and extending longitudinally in most cases. The apparatus is then coupled to the towing vehicle via the towing assembly. The vehicle that needs to be towed then boards the towing apparatus, either via ramps or when the apparatus is lowered in a manner to allow boarding, and is secured in place. If the vehicle is unable to board the towing apparatus under its own power, it can be winched on. The towing apparatus is then raised (if it was lowered) and towing can commence unobstructed.

### BRIEF DESCRIPTION OF THE DRAWINGS

Various embodiments are herein described, by way of example only, with reference to the accompanying drawings, wherein:

FIG. 1 is a top view of a schematic depiction of an embodiment of the invention in closed storage state;

FIG. 2 is a is a top view of a schematic depiction an embodiment of the invention in open load-bearing state;

FIG. 3 is an overview of an embodiment of the invention in use;

FIG. 4 is a side view of an embodiment of the invention in lowered state for vehicle entry and exit;

FIG. 5 is a side view of an embodiment of the invention in raised state for travelling;

FIG. 6 is a back view of an embodiment of the invention in raised state with an exemplary vehicle thereon;

FIG. 7 is a schematic top view of a second embodiment of the invention with an exemplary vehicle entering therein.

FIG. 8 is a schematic side view of the second embodiment of the invention in lowered state.

FIG. 9 is a schematic side view of the second embodiment of the invention in raised state.

FIG. 10 is a top view of a schematic depiction of an embodiment of the invention in open load-bearing state with a winch.

### DESCRIPTION OF THE PREFERRED EMBODIMENTS

The principles and operation of a towing apparatus (cart) according to the present invention may be better understood with reference to the drawings and the accompanying description.

The term ‘expand’ as used herein denotes the act or state of separation between two elements, whereas the term ‘extend’ as used herein denotes the act or state of increased overall length of a given element.

The term ‘transverse’ as used herein refers to the direction perpendicular to the direction in which the towing apparatus moves.

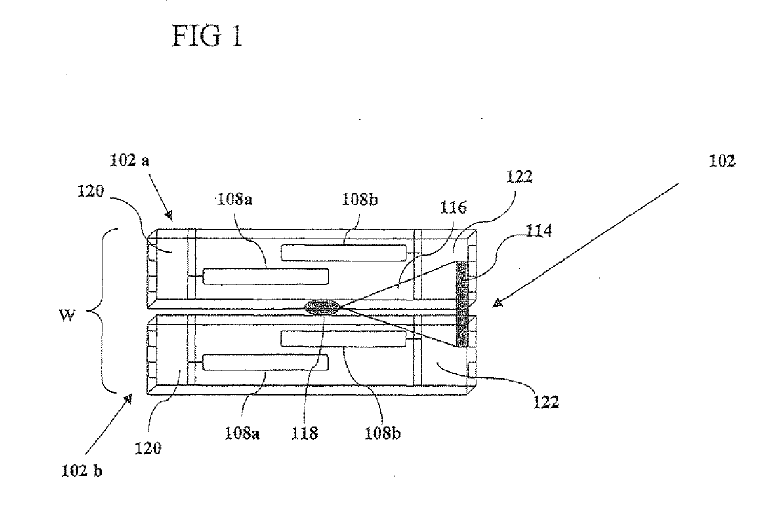

Referring now to the drawings, FIG. 1 illustrates, schematically, a top view of a towing cart 102 in compacted, storage state. Towing cart 102 consists of a load-bearing platform 102a and a second, parallel, load-bearing platform 102b, which are operationally coupled together via hydraulic cylinders (not shown) over width W. A vehicle ramp 120 is pivotally mounted on load-bearing platform 102a via reinforced hinges (not shown) at the vehicle entry/exit end. A platform extension member 122 is pivotally mounted on load-bearing platform 102a via reinforced hinges not shown) at the towing end. A hydraulic cylinder 108a is mounted on load-bearing platform 102a and operationally coupled to ramp 120 and a second hydraulic cylinder 108b is mounted on load-bearing platform 102a and operationally coupled to extension member 122. A similar arrangement of a ramp 120, an extension member 122 and two hydraulic cylinders 108a and 108b is found on load-bearing platform 102b. A towing crossbar 114 is operationally coupled to towing cart 102 via telescopically extendable crossbars (not shown). Towing crossbar 114 is a significantly freely swiveling cylinder, encased within a slightly wider, fixed cylinder, allowing the crossbar to swivel freely according to need. In the current depiction towing crossbar 114 is shown lying substantially flat on top of load-bearing platforms 102a and 102b. A coupling device 118 for coupling trailer 102 to an exemplary vehicle (not shown) is operationally coupled to towing crossbar 114 via a towing bar arrangement 116.

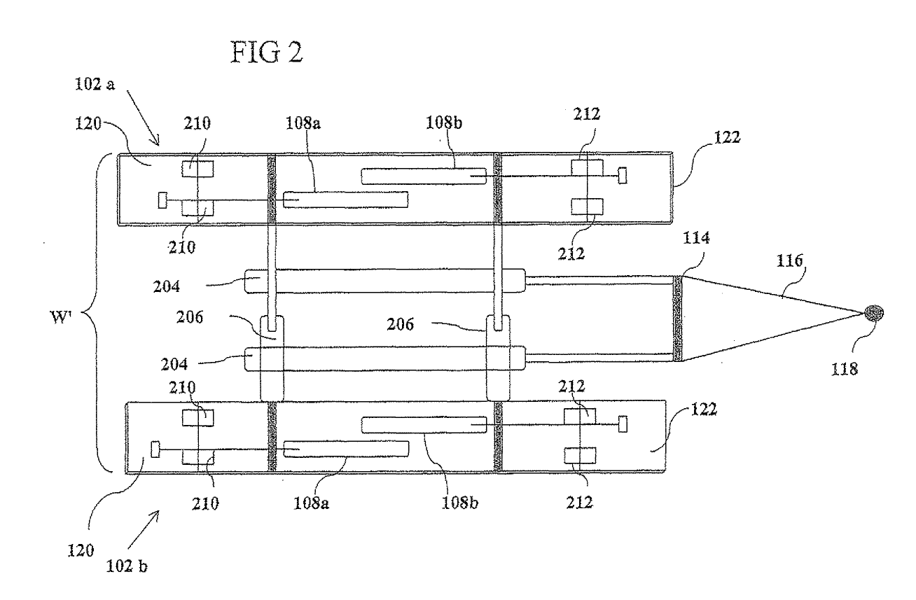

FIG. 2 illustrates, schematically, a top view of the cart in fully expanded and extended load-bearing state. Load-bearing platforms 102a and 102b, in the current embodiment, are intended to bear the load of a towed vehicle. Load-bearing platforms 102a and 102b are operationally coupled together via two hydraulic cylinders 206. Hydraulic cylinders 206 are extended to full capacity in order to separate the load-bearing platforms and move them from the fully compacted, storage state, (as depicted in FIG. 1) to the expanded, fully separated, load-bearing state currently depicted, now spanning width W′. Ramp 120 is pivotally mounted on load bearing platform 102a via two hinges 210. Hinges 210 are pivotal over a circumference of at least 225°. Hydraulic cylinder 108a is operationally extended to substantially full length, thereby unfolding ramp 120 along a rotational circumference of at least 225° to rest on the ground at a beveled angle. Extension member 122 is pivotally mounted on load-bearing platform 102a via two hinges 212. Hydraulic cylinder 108b is operationally extended to substantially full length, thereby unfolding extension member 122 to lie substantially flat, thereby extending the overall length of load-bearing platform 102a. A similar arrangement exists on load-bearing platform 102b.

Towing crossbar 114 is operationally coupled to two telescopically extendable crossbars 204. Telescopically extendable crossbars 204 are extended substantially fully, in the current depiction. Towing crossbar 114 is rotated in the direction of a towing vehicle (not shown).

When using the term ‘towing assembly’ it is to be appreciated that the term refers to towing crossbar 114, towing bar arrangement 116 and coupling device 118. In addition, it is to be appreciated by one skilled in the art that the described towing assembly is in no way intending to limit the current invention to a particular configuration but rather to provide an exemplary manner in which the current invention functions. The towing assembly depicted herein is intended to be operationally coupled to a towing vehicle (not shown).

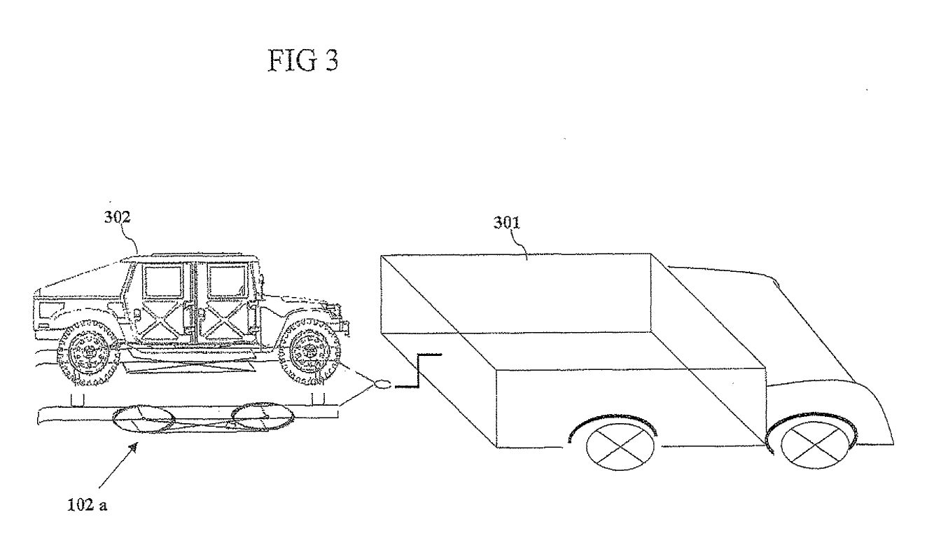

FIG. 3 is an overview of the invention in use where an exemplary vehicle 302 is being towed on towing cart 102 by an exemplary service vehicle 301.

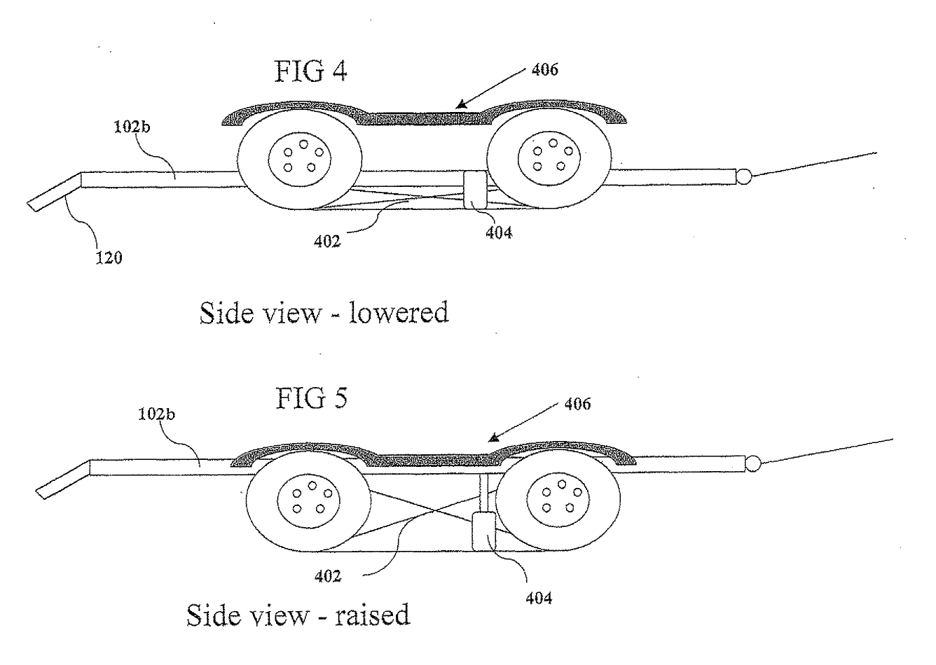

FIG. 4 is a schematic side view of an exemplary embodiment of the invention in lowered state for the purpose of vehicle entry/exit. There is depicted a hydraulically driven scissor lift 402 employed for the purpose of lowering and raising load-bearing platform 102b in order to allow for vehicle entry/exit and unobstructed travel respectively. Scissor lift 402 is situated beneath load-bearing platform 102b and operationally coupled thereto. Scissor lift 402 is lowered to a substantially collapsed state by retracting a hydraulic cylinder 404 substantially completely, thereby lowering load-bearing platform 102b substantially low so as to allow for vehicle entry and exit via ramp 120. It is to be understood that scissor lift 402 and ramp 120 may be employed independently of each other, as the above description is exemplary. In some embodiments of the invention scissor lift 402 may be employed without ramp 120, and in other embodiments ramp 120 may be employed without scissor lift 402. In addition, scissor lift 402 may be configured to lower the entry/exit end only, to allow entry of a towed vehicle.

In FIG. 5 there is depicted an embodiment of the invention in raised state for the purpose of traveling, where hydraulically driven scissor lift 402, which is positioned beneath load-bearing platform 102b, is elevated to the fully raised position by extending hydraulic cylinder 404, which is operationally coupled to thereto, to substantially full extent, thereby raising load-bearing platform 102b. Scissor lift 402 is operationally couple to a wheel assembly 406. A similar scissor lift 402 is located beneath load-bearing platform 102a and similarly coupled thereto. Scissor lifts 402 are intended to be raised and lowered in tandem to allow for the smooth raising and lowering of a towed vehicle.

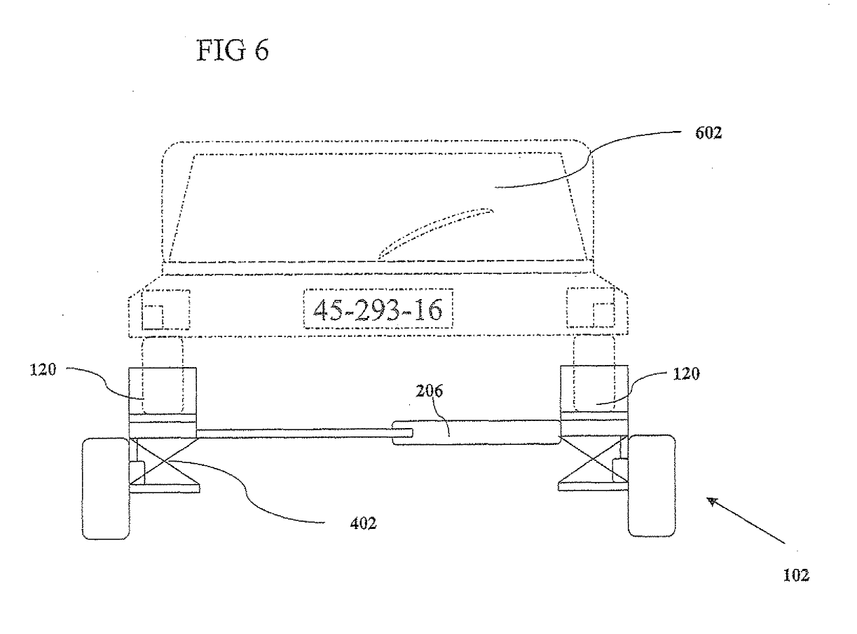

FIG. 6 depicts a schematic, back view of towing cart 102 in raised state with an exemplary vehicle 602 depicted thereon. In the current depiction, ramps 120 are rotated to a position essentially orthogonal to load-bearing platforms 102a and 102b. The abovementioned arrangement serves as an additional safety measure ensuring the safety of exemplary towed vehicle 602 above and beyond the apparatus (not shown) for fastening the vehicle in place. It is to be appreciated that operation of the towing apparatus, in some embodiments, may be executed completely manually, whereas in other embodiments this may be achieved through completely automated means and in still further embodiments some operations may be executed manually whereas others will be executed in an automated fashion. It should further be appreciated, by one skilled in the art, that certain components may be replaced with other similar components, or, in some embodiments, may be discarded completely.

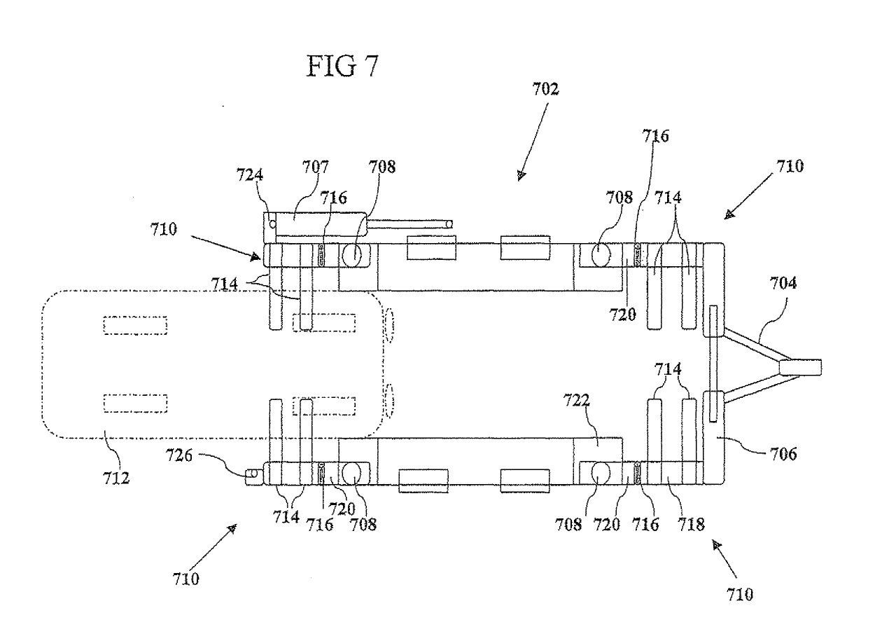

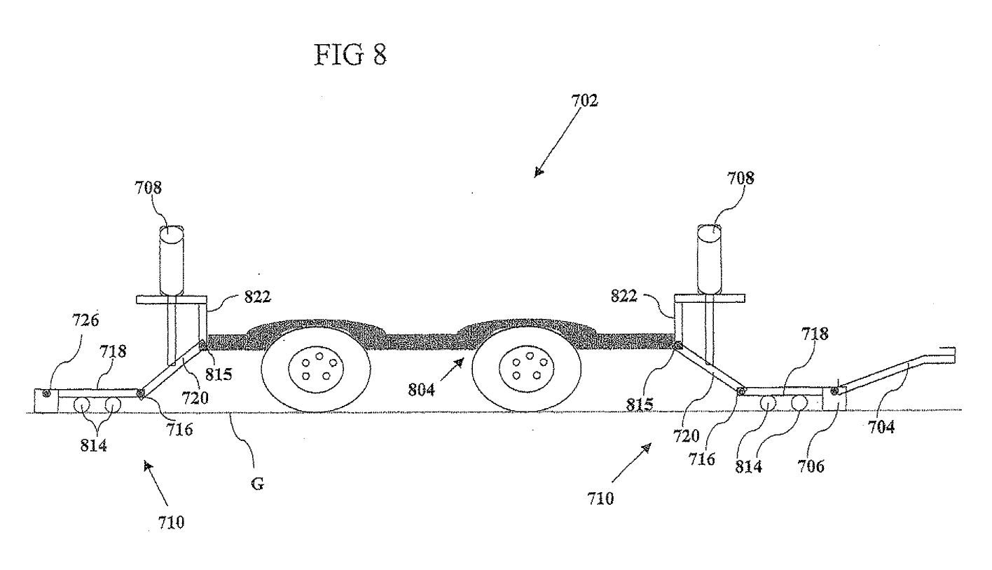

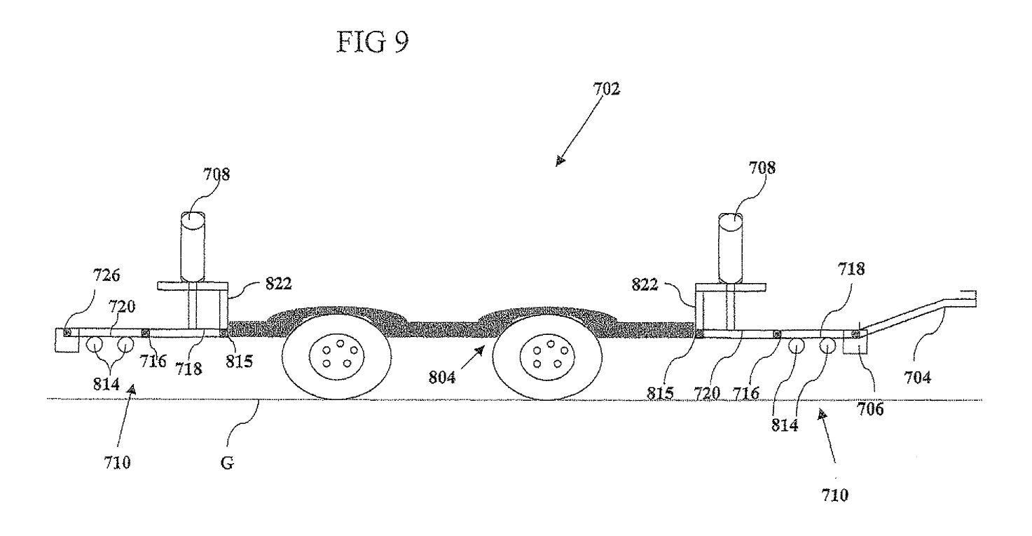

Another possible embodiment is shown in FIGS. 7-9. FIG. 7 is a top view of a towing apparatus 702. FIGS. 8 and 9 are two different side views. A hydraulic cylinder 706 is situated on the towing side and a second pivotable hydraulic cylinder 707 is situated on the vehicle entry/exit side. A load-bearing unit 710 includes the following elements: (a) two struts 714; (b) a hinge 716; (c) a platform 718; and (d) a second platform 720. A hydraulic cylinder 708 is mounted on a platform 722 and operationally coupled to load-bearing unit 710 via platform 729. Platform 720 is pivotally coupled to platform 718 via hinge 716. Platform 718 is operationally coupled to struts 714 via adjustable cogs (not shown). Towing apparatus 702 has four discernable states: (1) closed; (2) opened; (3) raised; and (4) lowered. In state (1), both hydraulic cylinders 706 and 707 axe contracted significantly fully. In state (2) both hydraulic cylinders 706 and 707 are extended significantly fully. In state (3), all four hydraulic cylinders 708 are contracted essentially fully, thereby raising all four load-bearing units 710. In this state, towing apparatus 702 can travel in an unobstructed manner. In state (4) hydraulic cylinders 708 are extended essentially fully thereby lowering load-bearing units 710. In this state, struts 714 are lying sufficiently low so as to allow an exemplary vehicle 712 to either enter or exit the towing apparatus in preparation for towing or after towing. Exemplary vehicle 712 is positioned on load bearing units 710 with each wheel of exemplary vehicle 712 positioned between two struts 714. Struts 714 are horizontally adjusted, via 2 cogs 814 in order to adequately secure each wheel of the towed vehicle. Once exemplary vehicle 712 has entered towing apparatus 702, hydraulic cylinder 707 is pivotally rotated on a hinge 724 and secured by a safety latch 726. Hydraulic cylinders 708 are operationally contracted essentially completely, thereby raising load-bearing units 710 as well as exemplary vehicle 712 thereon. A schematic side view of towing apparatus 702 in lowered sate is depicted in FIG. 8. A schematic side view of towing apparatus 702 in raised state is depicted in FIG. 9. In FIGS. 8 and 9 a hinge 815 is visible as are adjusting cogs 814. Hinges 815 are mounted on either end of a wheel assembly 804. An “L” shaped support 822 for hydraulic cylinder 708 is mounted on either end of wheel assembly 804. Adjusting cogs 814 are operationally coupled to parallel struts 714. Struts 714 are horizontally adjustable via cogs 814 to both secure towed vehicles as well as allow for vehicles of different lengths to be towed. A trailer tongue assembly 704 is operationally coupled to a hydraulic cylinder 706. Trailer tongue assembly 704 is intended to be operationally coupled to a service vehicle (not shown) via conventional means for coupling (e.g. hitch and ball, electric plug etc.).

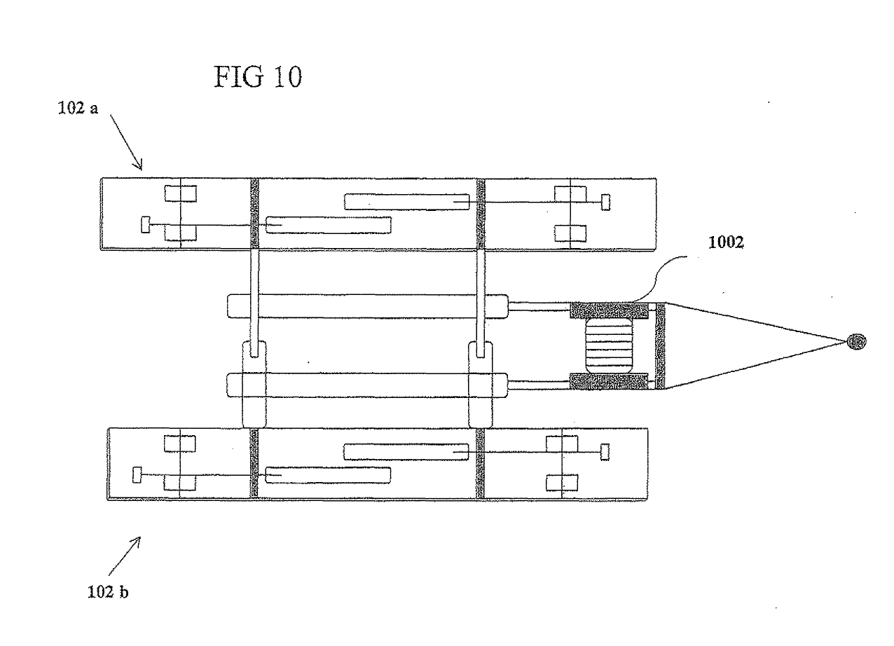

FIG. 10 depicts an embodiment of the invention where a winch 1002 is mounted on the towing apparatus. It is to be appreciated that the entry of a towed vehicle onto a towing apparatus is conventionally effected by operationally coupling the towed vehicle to a winch assembly via metal cable which is then ‘winched in’ pulling the towed vehicle onto the towing apparatus. The winch is conventionally situated on the towing vehicle. Alternately, as depicted in FIG. 10, winch 1002 is situated on the towing apparatus. While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. A towing apparatus comprising:
a. at least two parallel wheel assemblies,
b. at least one load-bearing platform, operationally coupled to at least one of said wheel assemblies, and
c. an expansion mechanism for changing a transverse distance between said two parallel wheel assemblies to reversibly configure the towing apparatus alternately between a closed state and an open state.

2. The apparatus of claim 1 further comprising:
d. two ramps for enabling a vehicle to move onto and off of said at least one load-bearing platform.

3. The apparatus of claim 1 wherein the towing apparatus comprises two load bearing platforms that are substantially adjacent to each other when the towing apparatus is in said closed state.

4. The apparatus of claim 1 where said expansion mechanism includes two hydraulic cylinders operationally coupled to said at least one load-bearing platform.

5. The apparatus of claim 4 where one of said two hydraulic cylinders also serves as a gate for securing a towed vehicle.

6. The apparatus of claim 5 further comprising:
d. a safety latch for securing said hydraulic cylinder when said hydraulic cylinder serves as said gate.

7. The apparatus of claim 1 wherein the towing apparatus comprises four load-bearing platforms for being positioned beneath four wheels of a towed vehicle wherein each of said load-bearing platforms includes two parallel struts, a first said strut for being positioned behind one of said wheels of said towed vehicle and a second said strut for being positioned in front of said wheel, for each of said four wheels.

8. The apparatus of claim 7 where each load-bearing platform includes a mechanism for adjusting a distance between said two parallel struts.

9. The apparatus of claim 1, wherein the towing apparatus is adapted to be reversibly configured alternately in a lowed state for vehicle entry and exit and in a raised state for unobstructed travel.

10. The apparatus of claim 9 further comprising at least one scissor lift for reversibly configuring the towing apparatus alternately in said lowered state and said raised state.

11. The apparatus of claim 9 further comprising at least one hydraulic cylinder for reversibly configuring the towing apparatus alternately in said lowered stand and in said raised state.

12. The apparatus of claim 9 further comprising:
d. two ramps for moving a vehicle onto and off of said at least one load-bearing platform.

13. The apparatus of claim 9 where said at least one load-bearing platform is configured in said lowered state to lie sufficiently low so as to allow entry and exit of a towed vehicle.

14. The apparatus of claim 12 where said two ramps are adapted to be positioned perpendicular to said at least one load-bearing platform to secure a towed vehicle.

15. The apparatus of claim 1 wherein a width of the towing apparatus, when configured in said closed state, is at most about 50% of a width of the towing apparatus when configured in said open state.

16. The apparatus of claim 1 wherein a width of the towing apparatus, when configured in said closed state, is at most about 30% of a width of the towing apparatus when configured in said open state.

17. The apparatus of claim 1 where a width of the towing apparatus, when configured in said closed state, is at most about 10% of a width of the towing apparatus when configured in said open state.

18. The apparatus of claim 1 further comprising a winch for operatively moving a vehicle onto and off of the towing apparatus.
